(19) United States
(12) Patent Application Publication
(10) Pub. No.: US 2015/0302575 A1
(43) Pub. Date: Oct. 22, 2015

(54) SUN LOCATION PREDICTION IN IMAGE SPACE WITH ASTRONOMICAL ALMANAC-BASED CALIBRATION USING GROUND BASED CAMERA

(71) Applicant: Siemens Aktiengesellschaft, Munich (DE)

(72) Inventors: Shanhui Sun, Plainsboro, NJ (US); Jan Ernst, Plainsboro, NJ (US); Joachim Bamberger, Munich (DE); Jeremy Ralph Wiles, Graefenberg (DE)

(21) Appl. No.: 14/711,002

(22) Filed: May 13, 2015

Related U.S. Application Data
(63) Continuation-in-part of application No. 14/255,154, filed on Apr. 17, 2014.

(51) Int. Cl. G06T 7/00; G06T 3/00; H04N 5/225; G06T 15/04; G06T 17/20; G06K 9/00; G01W 1/10; G06T 7/20

(52) U.S. Cl. CPC G06T 7/004; G01W 1/10; G06T 3/0006; G06T 7/208; G06T 7/0018; G06T 15/04; G06T 17/20; G06K 9/0063; H04N 5/225; G06T 2207/20061; G06T 2200/21; G06T 2207/10004; G06T 2207/10028; G06T 2207/30241; G06T 2210/61

(57) ABSTRACT

A method for predicting location of the sun in an image space. The method includes providing a set of calibration images and offline intrinsic calibration of a camera and optical element. An extrinsic parameter calibration is then performed based on the calibration images and mapping between local three dimensional coordinates and real world three dimensional coordinates to provide an extrinsic projection matrix. The method also includes providing a real time image of the sky and determining sun location in spherical space based on the extrinsic projection matrix and a real time sun location in the world coordinate system for the real time image. A three dimensional vector is then mapped to provide a corrected two dimensional ideal point. Next, an inverse affine transformation is performed to provide a two dimensional real image point in image space.

### CROSS REFERENCE TO RELATED APPLICATION

This application is a continuation-in-part application of U.S. application Ser. No. 14/255,154 filed on Apr. 17, 2014 and entitled SHORT TERM CLOUD COVERAGE PREDICTION USING GROUND-BASED ALL SKY IMAGING the disclosure of which is hereby incorporated by reference in its entirety.

### FIELD OF THE INVENTION

The present invention relates generally to sun location prediction, and more particularly, to sun location prediction in an image space using astronomical almanac-based calibration and a ground based camera.

### BACKGROUND OF THE INVENTION

The variability of available solar energy presents a significant challenge with respect to power generation in a photovoltaic (PV) power plant. An important factor in the variability of available solar energy is the sky condition. Cloud cover is one of the key elements in the sky that causes variability in available solar energy. For example, when the sun is significantly covered by clouds, the solar irradiance received by the solar panels of the PV power plant decreases whereas when the sun is clear, there is a near constant solar irradiance received by the solar panels.

In order to avoid or substantially reduce the variability of power supplied to a power grid, a backup power supply is used to compensate for the variability in available solar power supply. In particular, the backup power supply may be a backup battery or another power generation source. Once the solar power supply is stable due to sufficient solar irradiance, the backup power supply is shut down in order to reduce energy waste and costs. It is desirable to accurately predict sun location in an automated system for a PV power plant that uses computer vision to ensure accurate switching between backup power and solar power.

### SUMMARY OF THE INVENTION

Embodiments of the present invention address and overcome one or more of the above shortcomings and drawbacks, by methods, systems, and apparatuses for predicting cloud coverage using a ground-based all sky imaging camera. This technology is particularly well-suited for, but by no means limited to, solar energy applications.

A method for predicting location of the sun in an image space by utilizing a camera and an optical element having an effective view point is disclosed. The method includes providing a set of calibration images of a sky with the camera to form a set of calibration images and determining a sun location in a world coordinate system for each calibration image. The method also includes annotating each calibration image to provide annotated points and performing an affine transformation on each annotated point to provide corrected two dimensional ideal points. Each corrected two dimensional point is then mapped to obtain a corresponding three dimensional vector. Next, an extrinsic projection matrix is determined from image scene point correspondence information and a corresponding sun location in the world coordinate system. A real time image of the sky is then provided. In addition, the method includes determining sun location in spherical space to provide a three dimensional vector, wherein the sun location is spherical space is based on the extrinsic projection matrix and a real time sun location in the world coordinate system for the real time image. Further, the method includes mapping the three dimensional vector to provide a corrected two dimensional ideal point and performing an inverse affine transformation to provide a two dimensional real image point in image space.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides an overview of a system for predicting cloud coverage of a future sun position, according to some embodiments of the present invention;

FIG. 2 provides system overview of the processing of the Sun Location Prediction Module, according to some embodiments of the present invention;

FIG. 3 provides an overview illustration of the prediction system, as used in some embodiments of the present invention;

FIG. 4 provides an overview illustration of the Tracking/Flow Module, according to some embodiments of the present invention;

FIG. 5 depicts an example of a process that may be used for generating the filtered velocity field using Kalman filtering, according to some embodiments of the present invention;

FIG. 6 provides an overview of a process for predicting cloud coverage of a future sun position, according to some embodiments of the present invention; and

FIG. 7 illustrates an exemplary computing environment within which embodiments of the invention may be implemented.

FIG. 8 depicts a camera model for illustrating a method for predicting location of the sun in an image space when using a ground based camera.

FIG. 9 depicts a geocentric system wherein the camera is located at the origin of a world coordinate system.

FIGS. 10A-10B are first and second exemplary calibration images of the sky captured by the camera using relatively long and short exposures, respectively.

FIGS. 11A and 11B depict offline and online stages, respectively, of the current invention.

FIGS. 12A-12D are first, second, third and fourth images, respectively, of the sky wherein each image includes a circle for indicating the location of the sun in the image.

### DETAILED DESCRIPTION OF THE INVENTION

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following disclosure describes the present invention according to several embodiments directed at methods, systems, and apparatuses for providing short-term predictions of sun occlusion at a future time based on acquired sky images, cloud velocity measured based on those images, and knowledge of a future sun position. For example, in one embodiment, the overall prediction process works as follows: the estimated cloud velocity at time t0 is determined from the regularized flow algorithm, the sun position in the image at time t0+dt is obtained, where dt is the temporal range that is desired to be predicted. Then, a back-propagation algorithm is used to propagate the sun location to time t0 using the velocity information at time t0. Then, the segmentation module may be used to compute the cloud coverage in the sun region at time t0+dt (ground truth) and time t0 (prediction). The measurement of prediction error is the absolute difference between the estimated sun coverage in sun region and the coverage in the back-propagated sun region. The techniques described herein make a reasonable assumption that the solar irradiance is highly dependent on the cloud coverage and hence a precise prediction of cloud coverage leads to the precise prediction of solar irradiance. With this assumption and simplification, we then predict the occlusion of sun at different temporal ranges. The system includes data acquisition, cloud velocity estimation, sun location back-propagation, cloud segmentation module and prediction module.

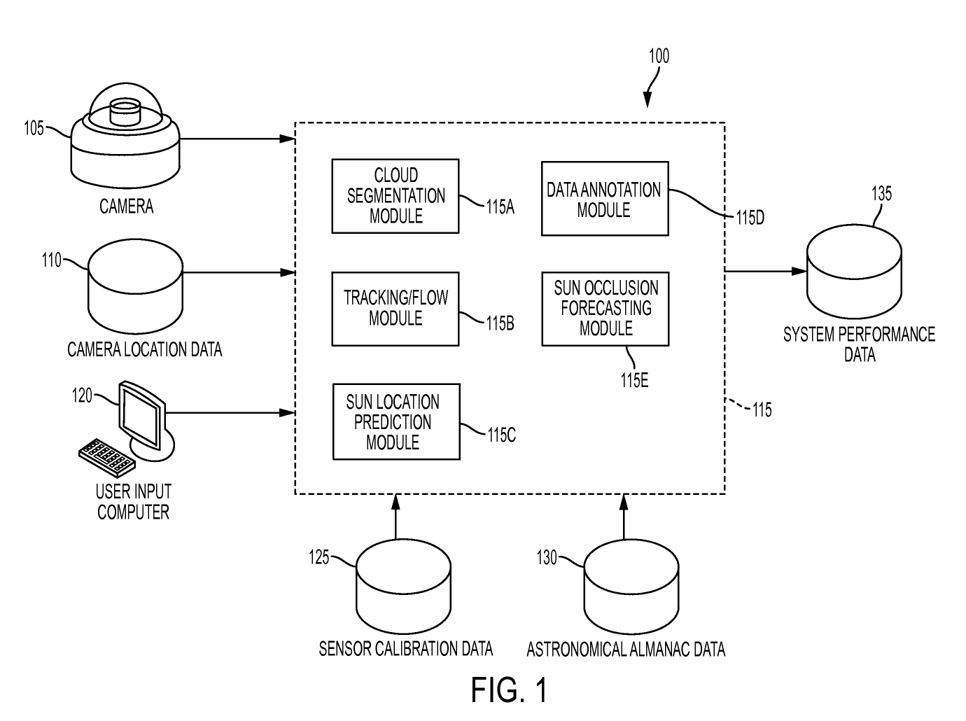

FIG. 1 provides an overview of a system 100 for predicting cloud coverage of a future sun position, according to some embodiments of the present invention. The system includes a data processing system 115 that receives input from a variety of sources, including a camera 105. The camera 105 may be used to capture sky images at predetermined intervals (e.g., 5 seconds). Prior to use, the camera may be calibrated using specialized software, Camera Location Data 110, and Sensor Calibration Data 125 to yield a camera intrinsic matrix and fisheye camera model. The images captured by the camera 105 may then be projected from image space to sky space. The parameters needed for this projection are available after the calibration of the camera.

The system 100 utilizes a trained cloud segmentation model to identify clouds in image data. To construct the training data utilized by the model, a predetermined number of cloud and sky pixels (e.g., 10,000 of each) are randomly sampled from annotated images. The system 100 includes a User Input Computer 120 which allows users to view sky images and select pixels as “cloud” or a “sky” (i.e., non-cloud). This selection can be performed, for example, by the user selecting individual portions of the image and providing an indication whether the selected portions depict a cloud. The data supplied by the User Input Computer 120 is received and processed by a Data Annotation Module 115D which aggregates the user's annotation data and supplies it to a Cloud Segmentation Module 115A. The Cloud Segmentation Module 115A then constructs a binary classifier which can classify new pixels at runtime as cloud or sky based on the training model.

The features used by the Cloud Segmentation Module 115A to represent sky and cloud pixels can include, for example, color spectrum values and a ratio of red and blue color channels. With respect to color spectrum values, in one embodiment, the Hue (H), Saturation (S) and Value (V) color space is used. It can be observed that sky and cloud pixel values lie in different spectrums in H. Similarly sky pixels have more saturation compared to cloud pixels. V may be used to represent brightness. With respect to the ratio of red and blue color channels, it is understood in the art that the clear sky scatters blue intensities more whereas cloud scatters blue and red intensities equally. Hence, a ratio of blue and red color intensities in the images can be used to distinguish between sky and cloud pixels. In one embodiment, a simple ratio of red (r) and blue channel (b) is used:

$$RBR = \frac{b}{r} \qquad ( 1 )$$

In other embodiments, a normalized ratio of red and blue channel is used:

$$RBRn = \frac{b - r}{b + r} \qquad ( 2 )$$

In yet another embodiment, a different normalized ratio of channels given by ratio of red channel to the maximum of red and blue channel.

$$RBRn 2 = \frac{r}{max ( r , b )} \qquad ( 3 )$$

In another embodiment, a difference between the value of red channel and blue channel is employed.

RBRdiff=(r−b) (4)

The features used by the Cloud Segmentation Module 115A to represent sky and cloud pixels may also include variance values and/or entropy values. Variance provides the measure of spread of the pixels values. In one embodiment, for each pixel in the cloud or sky region, the variance in the N×N neighborhood is computed. For fast computation of variance, integral images for sum image may be used as well as square of intensities image. Entropy provides the textural information about the image. Similar to the variance, for each pixel in the cloud or sky region, the entropy in the N×N neighborhood may be defined as follows:

$$Entropy = - {\sum }_{i ∈ ( 0.255 )} {p}_{i} log ( {p}_{i} ) \qquad ( 5 )$$

where pᵢ is calculated using histogram of image intensities.

Utilizing the cloud velocity, the future sun position may be back-propagated by reversing the velocity components. For example, if the current time is t0 and a prediction of cloud coverage is desired at t0+dt, the sun location at time t0+dt may first be determined. Then, the sun is propagated to t0 based on the velocity calculated at t0. In some embodiments, to simplify processing, the wind speed is assumed to be constant and local cloud evolution is not considered during the prediction period.

Returning to FIG. 1, at runtime, a Sun Location Prediction Module 115C predicts the location of the sun at a future point in time. In the example of FIG. 1, sun location is predicted based on Astronomical Almanac Data 130. However, in other embodiments, different techniques may be used for predicting sun position such as, without limitation, mathematical modeling based on known geophysical constants. The camera 105 captures multiple sky images which are used by a Tracking/Flow Module 115B to calculate a velocity field for the sky. Then, a Sun Occlusion Forecasting Module 115E utilizes the future location of the sun and the velocity field to determine cloud coverage of the future location. More specifically, a group of pixels at the future location of the sun are designated as the “sun pixel locations.” Utilizing the velocity field, the Sun Occlusion Forecasting Module 115E backward-propagates the sun pixel location by reversing the velocity components. For example, if the current time is t0 and a prediction of cloud coverage is desired at t0+dt, the sun location at time t0+dt may first be determined. Next, the sun pixels corresponding to that location are propagated to t0 based on the velocity calculated at t0. In some embodiments, to simplify processing, the wind speed is assumed to be constant and local cloud evolution is not considered during the prediction period. Then, the Cloud Segmentation Module 115A uses the aforementioned classifier to determine whether these pixel locations include clouds. If the pixels do include clouds, the future sun location is considered occluded. Following each classification, or on other intervals, system performance data 135 may be outputted which may be used, for example, for system benchmarking.

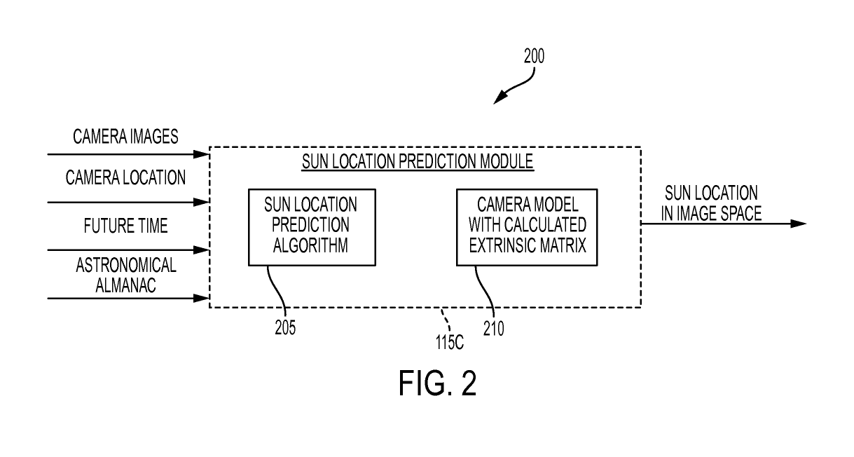

FIG. 2 provides system overview 200 of the processing of the Sun Location Prediction Module 115C, according to some embodiments of the present invention. The Sun Location Prediction Module 115C receives the following inputs: one or more camera images, an indication of the geographical location of the camera, a future time value for which a prediction is being sought, and astronomical almanac data. A Sun Location Prediction Algorithm 205 obtains the 3D world sun position from an astronomical almanac data in terms of future time and camera's geographical location. The 3D world sun position may then be used to find corresponding position in the image space by extrinsic projection and the camera model. A Camera Model with a Calculated Extrinsic Matrix 210 is used for mapping the 3D world sun position to image space. In one embodiment, the Calculated Extrinsic Matrix 210 is obtained using 55 annotations from different time points with the re-projection error 2.1+/−1.3 pixels.

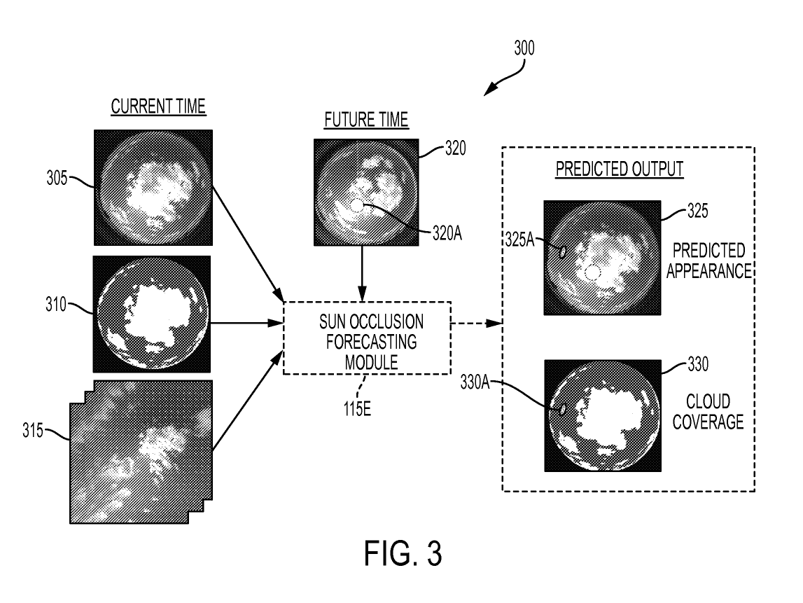

FIG. 3 provides an overview illustration 300 of the prediction system, as used in some embodiments of the present invention. Predictions of sun occlusion are performed via a Sun Occlusion Forecasting Module 115E. Inputs into the Sun Occlusion Forecasting Module 115E include a sky image at time t0 305, a segmented image 310 showing a binary segmentation of cloud and sky, cloud velocity estimation at time t0 315. Image 320 shows the sky image at a future time, t0+dt. The transparent circle 320A represents the actual sun location at time t0+dt as determined, for example, via Sun Location Prediction Module 115C. Conceptually, the output of the Sun Occlusion Forecasting Module 115E is a prediction of the appearance 325 and a prediction of the cloud coverage shown in image 330. Element 325A is the sun pixel location at t+t0 (shown by transparent circle 320A in image 320) back-propagated using the velocity information 315 at time t0. Image 330 shows the segmented image 310 highlighting the back-propagated sun pixel location 330A.

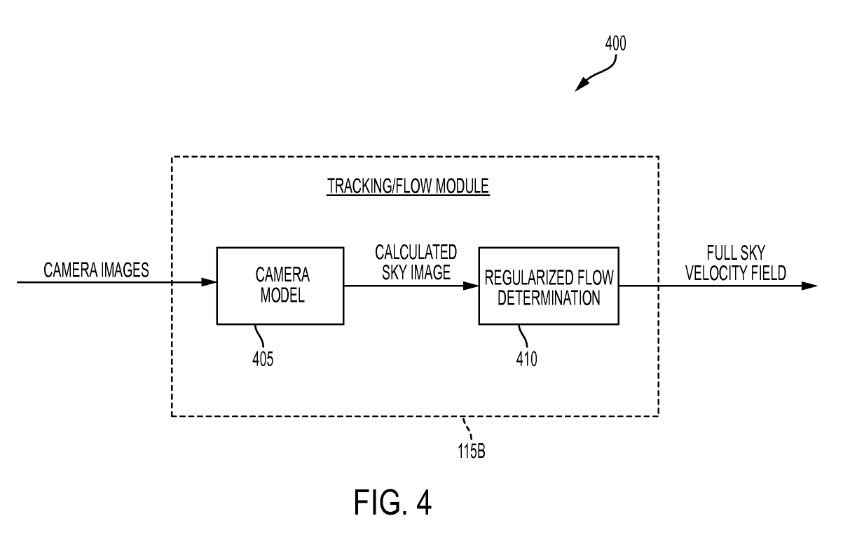

FIG. 4 provides an overview illustration 400 of the Tracking/Flow Module 115B, according to some embodiments of the present invention. A Camera Model 405 receives images captured by the camera 105 which projects these images from image space to sky space. In some embodiments, the Tracking/Flow Module 115B utilizes its own camera model, while in other embodiments it shares a camera model with another module. For example, in one embodiment the Camera Model 405 is the same camera model as shown at 210 in FIG. 2. Cloud velocity is estimated between a pair of images using spatially regularized optical flow algorithm, depicted as the Regularized Flow Determination module 410 in FIG. 4. This results in the output of the velocity field for the full sky.

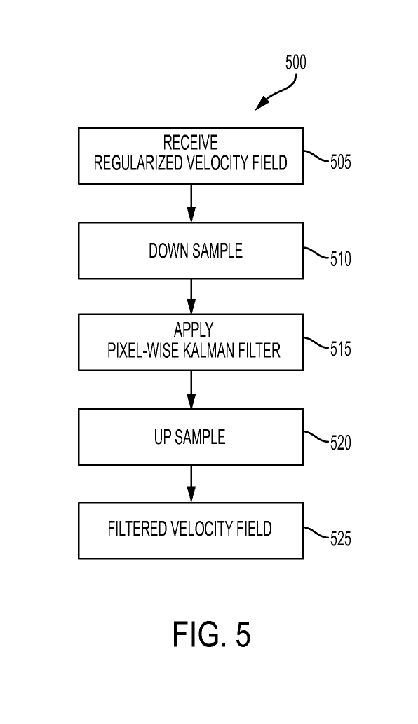

The flow observations between a pair of images can be noisy. To stabilize the tracking process and to incorporate temporal information in the current observation, in some embodiments a Kalman filter is employed. FIG. 5 depicts an example of a process 500 that may be used for generating the filtered velocity field using Kalman filtering, according to some embodiments of the present invention. At 505, the regularized, fine grained velocity field at t0 is received. Then, at 510, the field is down sampled by a predetermined factor (e.g., 4). At 515, a Pixel-Wise Kalman Filter is applied on the down sampled velocity field to generate a low resolution filtered velocity field. The Pixel-Wise Kalman Filter resembles a predictor-corrector algorithm. It provides an estimation of the process state at a particular time and then updates the predicted values by incorporating the measurements received at that particular time. In one embodiment, the Pixel-Wise Kalman Filter is set with 2 dynamic parameters and 2 measurement parameters. The dynamic and measurement parameters are the velocity vectors in x and y directions respectively. Returning to FIG. 5, at 520, the low resolution filtered velocity field is up sampled to original resolution. This results in locally smooth filtered velocity field which may then be used at 525 to back-propagate the sun location at time t0+dt.

Various algorithms for back-propagating the sun may be used within the scope of the present invention. For example, algorithms may differ in how they model the observed velocity information and/or how they filter the temporal information. In some embodiments, the back-propagation algorithm utilizes a global mean velocity field. More specifically, this algorithm constitutes the mean of the regularized velocity observed at time t0. Using this algorithm, each pixel in the sun location at time t0+dt is back-propagated with the same mean velocity obtained at time t0. In one embodiment, this algorithm is further modified through the use of a Kalman filter, incorporating additional temporal information from the previous frame pairs to provide smoothing, thus removing the noise in velocity estimation. In other embodiments, the back-propagation algorithm utilizes the full velocity field. This method uses a finer-grained model for the velocity propagation to better capture non-global behavior of the cloud motion. Specifically, the sun location at time t0+dt is propagated with the velocity field at each pixel at time t0. In other embodiments, the back-propagation algorithm utilizes the full velocity field with local and global Kalman filter. This incorporates the global mean velocity as well as fine grained local velocity with Kalman filtering using simple weighted sum model.

An additional variation of the back-propagation algorithm implemented in some embodiments is to utilize the full velocity field with a Monte Carlo approach. The locally filtered velocity provides a temporally and local spatially smooth information for back-propagation of sun location. However, it is sensitive to the noise in the estimation. Hence, the back-propagation may be modeled as a Monte Carlo like perturbation approach. Each pixel is propagated with the velocity of randomly sampled N points from the neighborhood with a radius r. The back-propagation process is the same as full flow back-propagation algorithm either with or without the Kalman filter. This results in N final propagated locations at t0. The predicted cloud coverage is determined by ΣNᵢ₌₁^{N}wᵢcᵢ, where cᵢ is the cloud coverage at a propagated location and wᵢ is a weigthing factor. In one embodiment, the weighting factor is set to wᵢ=1/N.

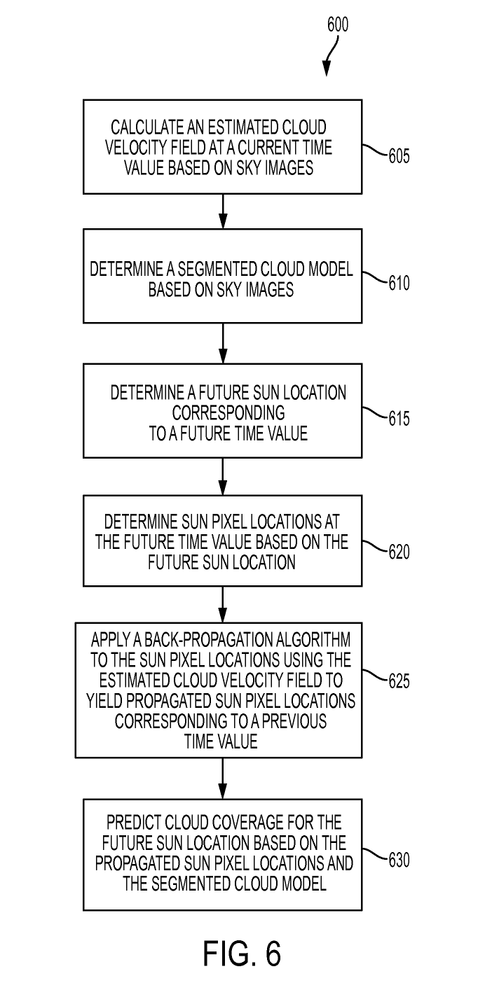

FIG. 6 provides an overview of a process 600 for predicting cloud coverage of a future sun position, according to some embodiments of the present invention. At 605, an estimated cloud velocity field at a current time value is calculated based on a plurality of sky images. Next, at 610 a segmented cloud model is determined based on the plurality of sky images. Then, at 615, a future sun location corresponding to a future time value is determined.

Continuing with reference to FIG. 6, at 620, sun pixel locations at the future time value are determined based on the future sun location. Next, at 625, a back-propagation algorithm is applied to the sun pixel locations using the estimated cloud velocity field to yield a plurality of propagated sun pixel locations corresponding to a previous time value. Then, at 630, cloud coverage for the future sun location is predicted based on the plurality of propagated sun pixel locations and the segmented cloud model. In some embodiments, the metric of evaluation is the difference in predicted vs. ground truth sun occlusion due to clouds. The following definitions of cloud coverage or the sun occlusion may be used:

cloudcover_{binary}=N_{c}/Nₛ (6)

where N_{c} is the number of cloud pixels in the sun region and Nₛ is the number of total pixels in the sun region, and/or

cloudcover_{probability}=P_{c}/Nₛ (7)

where P_{c}=Σ_{iε(1,N}_{ₛ}₎pᵢ and pᵢ is the probability of cloudiness at pixel i.

Additional refinements may be made to the techniques described in FIG. 6 to compensate for image artifacts that affect system performance. For example, in some sky images, a vertical strip of glare may appear in the center of sun (see, e.g., image 320 in FIG. 3). The vertical strip may result in the underestimation of flow and impacts the cloud segmentation. To mitigate this challenge, in some embodiments, the strip is automatically detected by converting the image into an edge map by running an edge detector and masking the region/strip that has the maximum intensity in the vertical direction. Additionally, due to the brightness of the sun near the circum-solar region, there is a high probability of clear sky being falsely detected as cloud. Adaptive thresholding for classification of cloud to overcome this issue often leads to mis-detection of thicker clouds. To avoid this problem in system evaluation, in some embodiments, the sun is perturbed to an off-sun position assuming a virtual sun in that location. This does not change the geometry and it reduces the variables in evaluation of the back-propagation methods described herein.

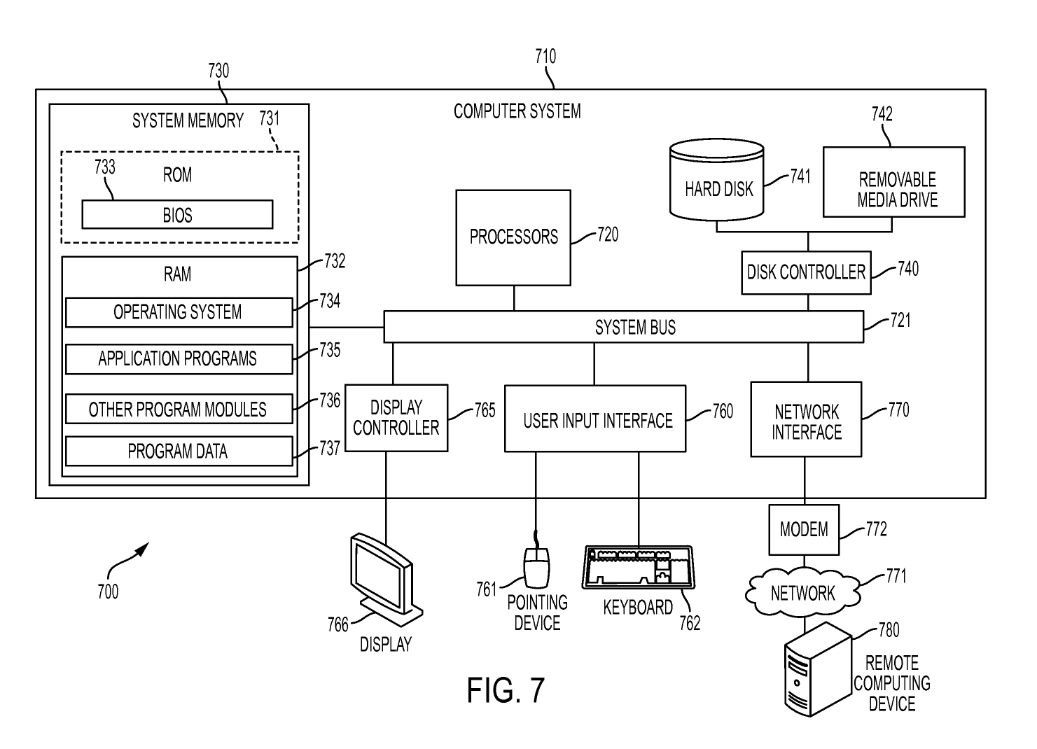

FIG. 7 illustrates an exemplary computing environment 700 within which embodiments of the invention may be implemented. For example, computing environment 700 may be used to implement one or more components of system 100 shown in FIG. 1. Computers and computing environments, such as computer system 710 and computing environment 700, are known to those of skill in the art and thus are described briefly here.

As shown in FIG. 7, the computer system 710 may include a communication mechanism such as a system bus 721 or other communication mechanism for communicating information within the computer system 710. The computer system 710 further includes one or more processors 720 coupled with the system bus 721 for processing the information.

The processors 720 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 7, the computer system 710 also includes a system memory 730 coupled to the system bus 721 for storing information and instructions to be executed by processors 720. The system memory 730 may include computer readable storage media in the form of volatile and/or nonvolatile memory, such as read only memory (ROM) 731 and/or random access memory (RAM) 732. The RAM 732 may include other dynamic storage device(s) (e.g., dynamic RAM, static RAM, and synchronous DRAM). The ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in the ROM 731. RAM 732 may contain data and/or program modules that are immediately accessible to and/or presently being operated on by the processors 720. System memory 730 may additionally include, for example, operating system 734, application programs 735, other program modules 736 and program data 737.

The computer system 710 also includes a disk controller 740 coupled to the system bus 721 to control one or more storage devices for storing information and instructions, such as a magnetic hard disk 741 and a removable media drive 742 (e.g., floppy disk drive, compact disc drive, tape drive, and/or solid state drive). Storage devices may be added to the computer system 710 using an appropriate device interface (e.g., a small computer system interface (SCSI), integrated device electronics (IDE), Universal Serial Bus (USB), or FireWire).

The computer system 710 may also include a display controller 765 coupled to the system bus 721 to control a display or monitor 766, such as a cathode ray tube (CRT) or liquid crystal display (LCD), for displaying information to a computer user. The computer system includes an input interface 760 and one or more input devices, such as a keyboard 762 and a pointing device 761, for interacting with a computer user and providing information to the processors 720. The pointing device 761, for example, may be a mouse, a light pen, a trackball, or a pointing stick for communicating direction information and command selections to the processors 720 and for controlling cursor movement on the display 766. The display 766 may provide a touch screen interface which allows input to supplement or replace the communication of direction information and command selections by the pointing device 761.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium, such as a magnetic hard disk 741 or a removable media drive 742. The magnetic hard disk 741 may contain one or more datastores and data files used by embodiments of the present invention. Datastore contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments of the invention and for containing data structures, tables, records, or other data described herein. The term “computer readable medium” as used herein refers to any medium that participates in providing instructions to the processors 720 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 741 or removable media drive 742. Non-limiting examples of volatile media include dynamic memory, such as system memory 730. Non-limiting examples of transmission media include coaxial cables, copper wire, and fiber optics, including the wires that make up the system bus 721. Transmission media may also take the form of acoustic or light waves, such as those generated during radio wave and infrared data communications.

The computing environment 700 may further include the computer system 710 operating in a networked environment using logical connections to one or more remote computers, such as remote computing device 780. Remote computing device 780 may be a personal computer (laptop or desktop), a mobile device, a server, a router, a network PC, a peer device or other common network node, and typically includes many or all of the elements described above relative to computer system 710. When used in a networking environment, computer system 710 may include modem 772 for establishing communications over a network 771, such as the Internet. Modem 772 may be connected to system bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing device 780). The network 771 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 771.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

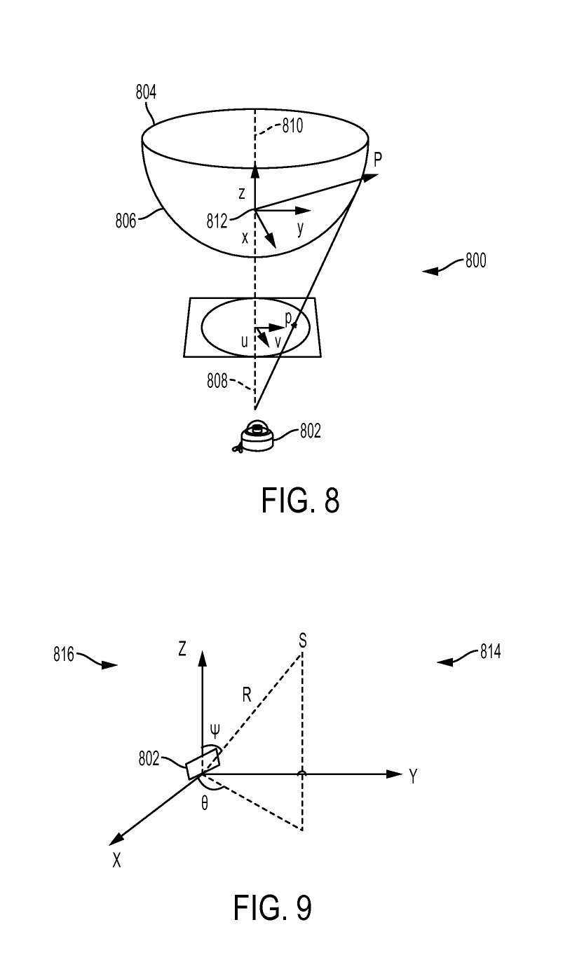

In another embodiment, it is desirable to also provide a method for predicting the location of the sun in the image space when using a ground based camera. Referring to FIG. 8, a camera model 800 for illustrating the invention is shown. The model 800 includes a pinhole camera 802 and an optical element such as a mirror 804 having a mirror surface 806, although it is understood that alternatively a fisheye camera having an optical element such as a fisheye lens may also be used in the model 800.

The method includes an offline calibration stage that is performed before an operational or online stage. As part of the offline calibration stage, intrinsic parameters of the camera are calibrated using specialized software. An example of such calibration software is known as the Omnidirectional Camera and Calibration Toolbox (OCamCalib) that is implemented in a programming language and computing environment known as MATLAB® available from The MathWorks, Inc. in Natick, Mass., USA. OCamCalib is publically available software that is available on the Internet. In this regard, the disclosures of documents entitled “A Flexible Technique for Accurate Omnidirectional Camera Calibration and Structure from Motion” by Scaramuzza, David et al., published in Proceedings of the Fourth IEEE International Conference on Computer Vision Systems (ICVS 2006), Jan. 4-7, 2006, New York, USA, pgs. 45-53, “A Toolbox for Easily Calibrating Omnidirectional Cameras” by Scaramuzza, David et al., published in Proceedings of the 2006 IEEE/RSJ 2006 International Conference on Intelligent Robots and Systems, Oct. 9-15, 2006, Beijing, China, pgs. 5695-5701 and “Automatic Detection of Checkerboards on Blurred and Distorted Images” by Rufli, Martin et al., published in IEEE/RSJ International Conference on Intelligent Robots and Systems, 2008, IROS 2008, Sep. 22-26, 2008, Nice, pgs. 3121-3126 are hereby incorporated by reference in their entirety. The camera 802 is calibrated with a plurality of checkerboard images (N). In an embodiment, 10 checkerboard images are used although it is understood that more or less than 10 checkerboard images may be used.

In the model, the camera 802 is first assumed to be a perfect camera, namely, that a camera axis 808 and a mirror axis 810 are perfectly aligned. Every optical ray reflected by the mirror surface 806 intersects into a unique point known as an effective viewpoint 812. In FIG. 8, (u, v) is an image coordinate system in an image plane and (x, y, z) is a three-dimensional (i.e. 3D) coordinate system. Mapping between a 3D vector P (x, y, z) representing an optical ray (emanating from the mirror effective viewpoint 812) and a two-dimensional (i.e. 2D) point p (u, v) is described in Eq. (8).

$$P = [ \begin{matrix}x \\ y \\ z\end{matrix} ] = [ \begin{matrix}u \\ v \\ f ( ρ )\end{matrix} ] , \qquad ( 8 )$$

where ƒ(ρ) is a polynomial function (see Eq. (9)) that maps an image point p into its corresponding 3D vector P and ρ=\sqrt{u²+v²}.

ƒ(ρ)=Σᵢ₌₁^{m}aᵢρⁱ (9)

where m=4 is used for the model 800. Parameters aᵢ are the intrinsic calibration results.

Distortion correction of the mirror is then considered through an affine transformation:

$$[ \begin{matrix}{u}^{′} \\ {v}^{′}\end{matrix} ] = [ \begin{matrix}c & d \\ e & 1\end{matrix} ] \cdot [ \begin{matrix}u \\ v\end{matrix} ] + [ \begin{matrix}{x}_{c} \\ {y}_{c}\end{matrix} ] , \qquad ( 10 )$$

where (u′, v′) are the real distorted coordinates (i.e. real image points) corresponding to ideal point (i.e. corrected 2D ideal point) (u, v) and c, d, e, x_{c}, y_{c} are parameters of a transformation matrix which are the remaining intrinsic calibration results. Alternatively, it is understood that Eq. (10) may be modified in a known manner to provide an inverse affine transformation wherein (u′, v′) is used to compute (u, v).

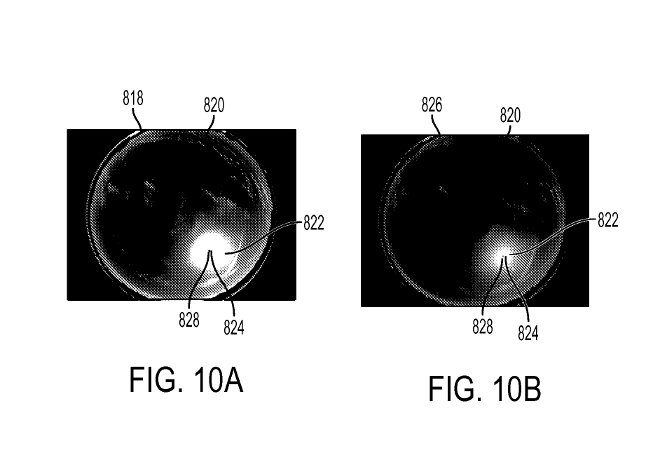

Once the intrinsic parameters are determined, 2D image points (u′, v′) inside a lens region are mapped to 3D points (x, y, z) on a unit sphere and vice versa. The sun is in a world 3D coordinate system. Referring to FIG. 9, a geocentric system 814 is utilized wherein the camera 802 is at the origin of a world coordinate system 816. Location of the sun S in this system 816 is described using three parameters as shown in FIG. 9: earth heliocentric radius (R), i.e. a distance from the camera 802 to the sun S, zenith angle (φ) and azimuth angle (θ). R, φ and θ may be obtained from a known astronomical almanac in terms of observation time and the geographical location of the camera 802. Alternatively, a known solar position algorithm may be used such as that described in a document entitled “Solar Position Algorithm for Solar Radiation Applications” by Reda, I., Andreas, A., published in Technical Report NREL/TP-560-34302, National Renewable Energy Laboratory (January 2008), which is hereby incorporated by reference in its entirety. Each image captured by the camera 802 therefore requires additional meta information such as the geographical location of the camera and corresponding time stamp. The corresponding Euclidean coordinates (X, Y, Z) are:

Z=R·cos(φ) (11)

X=R·sin(φ)·cos θ (12)

Y=R·sin(φ)·cos θ (13)

An extrinsic projection matrix M is then computed from a set of image-scene point correspondences, i.e. from a set {(u′ᵢ, Xᵢ)}ᵢ₌₁^{m}. Further,

xᵢ=M·Xᵢ (14)

where xᵢ are homogeneous 4-vectors representing unit spherical coordinates (x, y, z, 1) corresponding to image point (i.e. sun location in an image) u′ᵢ=(u′,v′). Xᵢ are homogeneous 4-vectors representing world points (X, Y, Z, 1). M is a 4×4 projection matrix with 12 free parameters and can be solved by a linear least squares method from m correspondences.

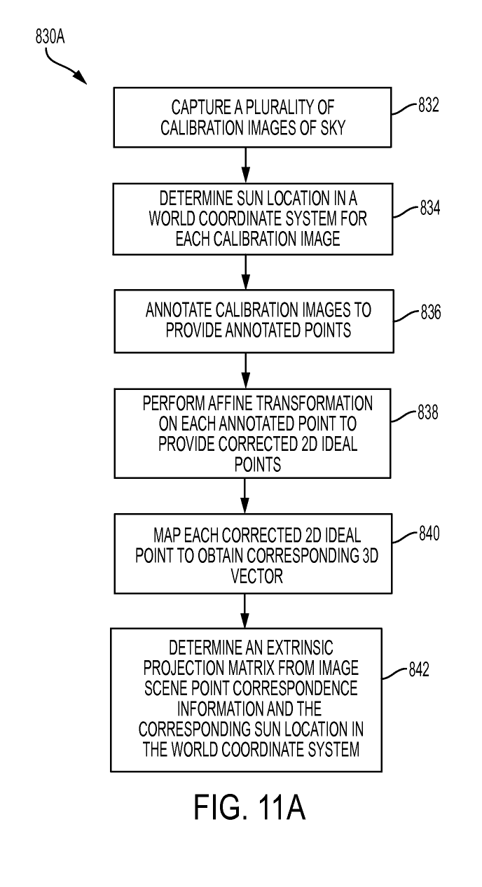

In order to find a set of image-scene point correspondences, a plurality of calibration images (i.e. a set of calibration images) are obtained by the camera 802. A sun point (i.e. center of the sun disc) is annotated on each of the calibration images. FIG. 10A depicts a first exemplary image 818 of the sky 820 captured by the camera 802 using a relatively long exposure. The first image 818 includes a sun disc 822 that is indicative of a position of the sun in the sky 820. A sun point 824 in the center of the sun disc 822 is then annotated. The annotation may be assisted by using a feature detection technique such as a Hough transform to identify a disc or circle in the first image 818. The annotation of the first image 818 is used to obtain xᵢ. Eqs. (11), (12) and (13) are then used to obtain Xᵢ. Thus, M may be calculated from Eq. (14) since both xᵢ and Xᵢ are known. Additional images may be captured and annotated to calculate M. In an embodiment, 12 images may be used.

Referring back to FIG. 10A, it is noted that regions in the first image 818 around and near the sun disc 822 appear saturated which may affect the ability to annotate the first image 818. In order to facilitate annotation, a shorter exposure time may be used which reduces saturation as shown in a second exemplary image 826 in FIG. 10B. The first 818 and second 826 images were taken at approximately 10:00 AM on Jun. 20, 2014. Note that the dot 828 in the sun disc 822 of the first 818 and second 826 images is generated as a result of a camera protection feature (i.e. a CMOS sensor of the camera protecting itself) and is not indicative of the center of the sun disc 822.

A plurality of images is then captured by the camera 802 during an online or operational stage of the method. An actual sun location (X, Y, Z) is computed for each image captured by the camera 802 in real time using Eqs. (11), (12) and (13) to obtain Xᵢ, wherein R, φ and θ are obtained by using a solar position algorithm or from a known astronomical almanac. A corresponding image point (u′, v′) is then computed from Eqs. (8), (9), (10) and (14) wherein M is known from the offline calibration stage and Xᵢ is previously computed from the real time images.

Thus, the invention includes a step wherein an intrinsic parameter calibration for a camera 802 and mirror 804 or camera 802 and a fisheye lens is performed. This is followed by an extrinsic parameter calibration wherein a projection matrix is used to map a local 3D coordinate system to an actual world coordinate system. Sun location in a world coordinate system is obtained from an astronomical almanac and/or a solar position algorithm. The calibration process is done offline. Calibrated intrinsic and extrinsic parameters are then used to map 3D sun location in the world coordinate system to the image space in terms of geographical location of the camera 802 and observation time point. The calibration is performed after the camera 802 and associated hardware are installed, thus enabling prediction of a future sun location from the calibrated camera geometry.

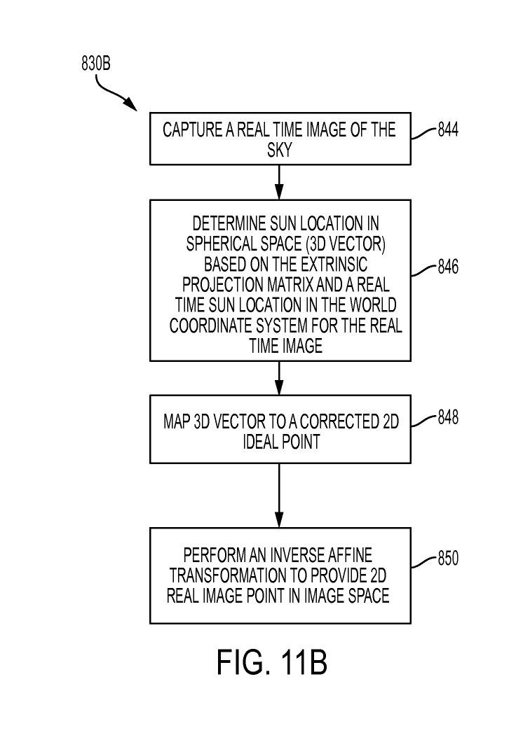

FIGS. 11A-11B depict flowcharts 830A and 830B, respectively, which illustrate aspects of the current invention. Flowchart 830A in FIG. 11A depicts steps for an offline stage of the invention. At step 832, a plurality of calibration images (i.e. a set of calibration images) of the sky is obtained. At step 834, location of the sun in a world coordinate system is determined for each calibration image. At step 836, each of the calibration images is annotated to provide annotated points. At step 838, an affine transformation is performed on each annotated point to provide corrected 2D ideal points. Next, each corrected 2D ideal point is mapped to obtain a corresponding 3D vector at step 840. At step 842, an extrinsic projection matrix is determined from image scene point correspondence information and the corresponding sun location in the world coordinate system. In an embodiment, Xᵢ and xᵢ in Eq. (14) are determined via steps 834 and 840, respectively, thus enabling determination of projection matrix M.

Flowchart 830B in FIG. 11B depicts steps for an online stage of the invention. At step 844, a real time image of the sky is captured. At step 846, location of the sun in spherical space (i.e. a 3D vector) is determined based on the extrinsic projection matrix and a real time sun location in the world coordinate system for the real time image. At step 848, the 3D vector is mapped to a corrected 2D ideal point (i.e. u, v). At step 850, an inverse affine transformation is performed to provide a 2D real image point (i.e. u′, v′) in image space as previously described. In an embodiment, step 846 is used to determine Xᵢ in Eq. (14) for the real time image. In addition, the previously determined projection matrix M from step 840 of FIG. 11A (i.e. offline stage) is used in step 846.

### Case Study

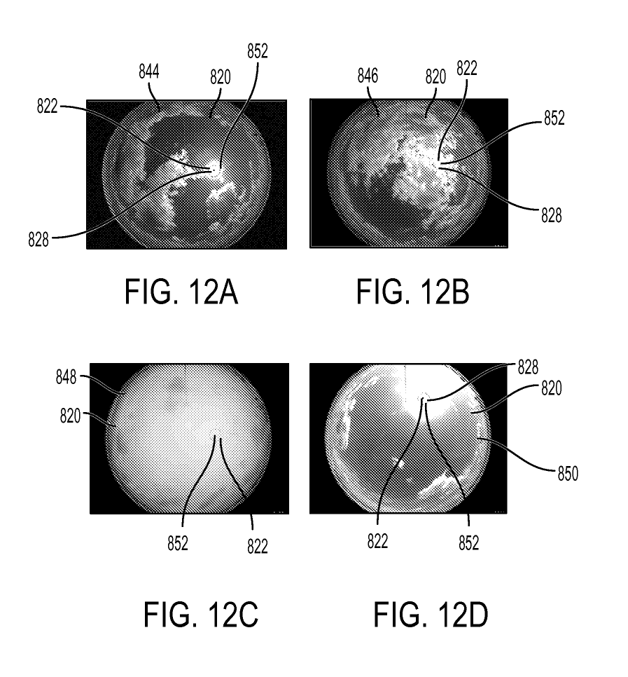

The current invention was evaluated in two different locations each using a different camera 802. The first camera 802 was a Moonglow Technologies All Sky camera which captured images while located at 755 College Road East, Princeton, N.J. 08540. Image size is 640×480 pixels. At this location, 55 sun annotations were used resulting in a re-projection error of 2.1±1.3 pixels. The second camera 802 was a Mobotix Q24M camera which captured images while located at 91058 Erlangen, Germany. Image size is 2048×1536 pixels. At this location, 12 sun annotations were used resulting in a re-projection error of 2.4±1.4 pixels. Referring to FIGS. 12A-12D, results of the sun location prediction method of the current invention are shown. In particular, FIGS. 12A-12D depict first 844, second 846, third 848 and fourth 850 images, respectively, of the sky 820 that were captured at 91058 Erlangen, Germany using the Mobotix Q24M camera. FIGS. 12A-12D show the location of the sun in each image 844, 846, 848, 850 as predicted by the method of the current invention. For purposes of illustration, a circle 852 is superimposed on the images 844, 846, 848, 850 to indicate the location of the sun in each image. It is noted that only the center of the sun is predicted (i.e. circle center). With respect to FIGS. 12A-12D, the first image 844 was captured approximately 01:24 PM on May 31, 2014, the second image 846 was captured approximately 01:48 PM on May 31, 2014, the third image 848 was captured approximately 01:24 PM on May 29, 2014 and the fourth image 850 was captured approximately 04:07 PM on May 31, 2014. As previously described, the dot 828 in the first 844, second 846 and fourth 850 images is not indicative of the center of the sun disc 822.

The current invention provides a sun location prediction method for use in a short term sun occlusion prediction system. The method is not affected by photometric variations or disturbances due to image intensity (for example, if the sun and nearby regions are saturated) or if the sun is totally or partially occluded by clouds. In another embodiment, the current invention may be used to compute an exposure window for a sun region so as to enable control of camera exposure time in a sky image acquisition system. The current invention may be used in a control system such as the Siemens SPPA-T3000 control system for power plants and/or in conjunction with smart grid technology. The current invention may also be used in computer vision based prediction systems.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof.

We claim:

1. A method for predicting location of the sun in an image space by utilizing a camera and an optical element having an effective view point, comprising:
providing a set of calibration images of a sky with the camera to form a set of calibration images;
determining a sun location in a world coordinate system for each calibration image;
annotating each calibration image to provide annotated points;
performing an affine transformation on each annotated point to provide corrected two dimensional ideal points;
mapping each corrected two dimensional point to obtain a corresponding three dimensional vector;
determining an extrinsic projection matrix from image scene point correspondence information and a corresponding sun location in the world coordinate system;
providing a real time image of the sky;
determining sun location in spherical space to provide a three dimensional vector, wherein the sun location is spherical space is based on the extrinsic projection matrix and a real time sun location in the world coordinate system for the real time image;
mapping the three dimensional vector to provide a corrected two dimensional ideal point; and
performing an inverse affine transformation to provide a two dimensional real image point in image space.

2. The method according to claim 1, wherein the sun location in the world coordinate system for the calibration images and the real time sun location in the world coordinate system are based on astronomical information and time.

3. The method according to claim 1, wherein the image scene point correspondence information is determined by annotating a sun point in each image of the set of calibration images.

4. The method according to claim 3, wherein a Hough transform is used to assist the annotation by identifying a circle in each image of the set of calibration images.

5. The method according to claim 3, wherein a relatively short exposure time is used to minimize saturation in the set of calibration images to assist in annotating the set of calibration images.

6. The method according to claim 1, wherein the extrinsic projection matrix is computed from a set of image scene point correspondences given by:
{(u′ᵢ,Xᵢ)}ᵢ₌₁^{m}
wherein u′ᵢ=(u′, v′) and Xᵢ are homogeneous 4-vectors representing world points (X, Y, Z, 1).

7. The method according to claim 6, wherein the extrinsic projection matrix is a 4×4 matrix having 12 free parameters.

8. The method according to claim 1, wherein at least 12 calibration images are captured.

9. The method according to claim 1, wherein the camera is a pinhole camera.

10. A method for predicting location of the sun in an image space by utilizing a camera and an optical element having an effective view point, comprising:
providing a set of calibration images to form a set of calibration images;
providing offline intrinsic calibration of the camera and optical element;
providing extrinsic parameter calibration based on the calibration images and mapping between local three dimensional coordinates and real world three dimensional coordinates to provide an extrinsic projection matrix;
providing a real time image of the sky;
determining sun location in spherical space to provide a three dimensional vector, wherein the sun location is spherical space is based on the extrinsic projection matrix and a real time sun location in the world coordinate system for the real time image;
mapping the three dimensional vector to provide a corrected two dimensional ideal point; and
performing an inverse affine transformation to provide a two dimensional real image point in image space.

11. The method according to claim 10, wherein the real time sun location is based on astronomical information and time.

12. The method according to claim 10, wherein the image scene point correspondence information is determined by annotating a sun point in each image of the set of calibration images.

13. The method according to claim 12, wherein a Hough transform is used to assist the annotation by identifying a circle in each image of the set of calibration images.

14. The method according to claim 12, wherein a relatively short exposure time is used to minimize saturation in the set of calibration images to assist in annotating the set of calibration images.

15. The method according to claim 10, wherein the extrinsic projection matrix is computed from a set of image scene point correspondences given by:
{(u′ᵢ,Xᵢ)}ᵢ₌₁^{m}
wherein u′ᵢ=(u′, v′) and Xᵢ are homogeneous 4-vectors representing world points (X, Y, Z, 1).

16. The method according to claim 15, wherein the extrinsic projection matrix is a 4×4 matrix having 12 free parameters.

17. The method according to claim 10, wherein at least 12 calibration images are captured.

18. The method according to claim 10, wherein the camera is a pinhole camera.

19. A system for predicting location of the sun in an image space by utilizing a camera and an optical element having an effective view point, comprising:
a processor;
a graphical display connected to the processor;
computer readable media including computer readable instructions that, when executed by processor, cause the processor to perform the following operations:
providing a set of calibration images of a sky with the camera to form a set of calibration images;
determining a sun location in a world coordinate system for each calibration image;
annotating each calibration image to provide annotated points;
performing an affine transformation on each annotated point to provide corrected two dimensional ideal points;
mapping each corrected two dimensional point to obtain a corresponding three dimensional vector;
determining an extrinsic projection matrix from image scene point correspondence information and a corresponding sun location in the world coordinate system;
providing a real time image of the sky;
determining sun location in spherical space to provide a three dimensional vector, wherein the sun location is spherical space is based on the extrinsic projection matrix and a real time sun location in the world coordinate system for the real time image;
mapping the three dimensional vector to provide a corrected two dimensional ideal point; and
performing an inverse affine transformation to provide a two dimensional real image point in image space.

20. The computer implement method according to claim 19, wherein the image scene point correspondence information is determined by annotating a sun point in each image of the set of calibration images.
